(19) United States
(12) Patent Application Publication
(10) Pub. No.: US 2004/0138996 A1
(43) Pub. Date: Jul. 15, 2004

(54) System and method for evaluating secondary market options for loans

(76) Inventors: Daniel Bettenburg, St. Paul, MN (US); Frank Docherty, Mound, MN (US)

Correspondence Address: Beck & Tysver, P.L.L.C., Suite 100, 2900 Thomas Avenue S., Minneapolis, MN, 55416, US

(21) Appl. No.: 10/688,321

(22) Filed: Oct. 17, 2003

Related U.S. Application Data
(60) Provisional application No. 60/419,501, filed on Oct. 18, 2002.
(60) Provisional application No. 60/419,500, filed on Oct. 18, 2002.

(51) Int. Cl. G06F 17/60

(52) U.S. Cl. 705/38

(57) ABSTRACT

A system and method is presented for providing a lender an automated best execution analysis of loan products from a plurality of investors. The present invention allows a lender to enter data into the system about a loan. The present invention screens the loan application against multiple possible investors, and selects those investors that would consider purchasing the loan. An automated system then submits the loan data to one or more automated loan evaluation systems to obtain purchase criteria and pricing decisions from the selected investors. In the preferred embodiment, the lender specifies how the data will be submitted to the automated systems based on the selected investors and predefined business rules. The system then determines which investors' criteria are met by the loan, and obtains comparison analysis data concerning the products of those investors. Finally, the present invention uses customizable business rules to determine the best offer for that particular loan.

This application claims priority to provisional application Serial No. 60/419,501, filed Oct. 18, 2002, and provisional application Serial No. 60/419,500, filed Oct. 18, 2002.

### FIELD OF THE INVENTION

This invention relates to the field of loan application processing. More particularly, the present invention relates to the utilization of an automated system to analyze secondary market options for a loan or loan application, such as a mortgage loan.

### BACKGROUND OF THE INVENTION

The lending industry has a well-established business flow for handling large volumes of loan applications, such as consumer mortgage loans. The consumer normally initiates the process by submitting a loan application to a lending professional. The lending professional is generally either a broker working with more than one lender, or the retail arm of a lender itself. The application is evaluated, and, if approved, the consumer and lender close on the loan.

Once the loan has been closed, the lender owns the loan. At this point, the lender has two options. It can retain the loan and manage it for its own portfolio, or it can sell the loan to a third party investor in the secondary market. Assuming the lender wishes to sell the loan to a third party, there are various factors that must be considered. First, the lender must identify the parties that are willing to purchase the loan in the secondary market. The lender must then determine which of those parties might be interested in purchasing the particular loan that the lender wishes to sell.

Some of the larger purchasers of mortgages in the secondary market, such as Fannie Mae (Washington, D.C.) or Freddie Mac (McLean, Va.), provide computerized systems to help lenders determine whether that purchaser would be interested in purchasing a particular loan. These automated purchase criteria and pricing systems can be used after a loan is closed or during the loan application phase itself. By allowing use of these engines at this early stage in the process, the lending professional is able to determine whether an investor in the secondary market would consider purchasing a loan before the loan closes and at what price.

Of course, some loans will be of interest to multiple loan purchasers, each of which may have a different set of criteria and pricing structure. In these instances, an analysis must be undertaken to determine which purchaser would provide the maximum benefit to the lender. This analysis is generally referred to as the secondary marketing process. The purchaser in this analysis is often referred to as an investor, and can serve as both a loan purchaser in one context and a lender in another context. Even with the assistance of the automated purchase criteria and pricing engines provided by the possible loan investors, it can be difficult to submit a single loan application to many investors. As a result, most lenders generally perform the secondary marketing process using an ad hoc, labor-intensive system. What is needed is a system that automates the secondary marketing process in a flexible, yet convenient way such that the system is able to help identify which loan purchaser is the best fit for a particular lender and a particular loan. Ideally, this best fit determination would be made using objective and measurable information such as the price quoted for a loan by a loan investor, as well as subjective information established by the lender such as the terms and conditions and ease in meeting the requirements for the loan specified by the investor.

### SUMMARY OF THE INVENTION

The present invention overcomes the limitations in the prior art by providing an automated best execution process that can be tailored to a lender's business requirements. This is accomplished by capturing the business knowledge already applied in the lender's current “ad hoc” procedures within an automated system that can be consistently applied on all secondary marketing decisions. By doing so, the present invention improves the quality of secondary marketing decisions and increases the capacity of a lender to make secondary marketing decisions. Furthermore, the present invention improves the profitability of the lender by reducing costs and increasing the revenue to be made with each loan application. Finally, the flexibility inherent in the present invention allows each lender to customize and actively manage the solution to fit its own business processes without requiring a “one-size-fits-all” solution.

This is accomplished by providing a system into which a lender or loan broker can enter data about a loan or loan application. The present invention then screens the loan application against multiple possible investors' criteria, and selects those investors that would consider purchasing the loan defined by the loan data. An automated system then processes the loan data against the purchase criteria and pricing information for the selected investors, such as by using the automated systems already provided by each investor. In the preferred embodiment, the lender is able to specify how the data will be submitted to the automated purchase criteria and pricing (“PC&P”) systems based on the selected investors and predefined business rules. The system then determines whether the loan criteria for the possible loan purchasers have been met, and obtains comparison analysis data for those investors. The comparison analysis data includes the price the investor will pay for the loan, and the conditions and requirements that the investor places on the loan before it will be accepted. Finally, the present invention uses customizable business rules to determine the “Best” offer for that particular loan.

Alternatively, a broker could use the present invention to analyze the loan products of a variety of lenders. Each of the lenders would have separate loan evaluation criteria, which in turn might be related to the purchase criteria of the investors that each lender typically utilizes. The present invention would then screen the loan application data against the separate criteria of the lenders.

### BRIEF DESCRIPTION OF THE DRAWINGS

FIG. 1 is a schematic drawing of the parties involved in a loan transaction.

FIG. 2 is a schematic drawing of a prior art secondary market process in which the criteria of multiple investors are combined into a simplified loan criteria for a lender.

FIG. 3 is a schematic drawing of a prior art automated PC&P system capable of accessing an external automated PC&P engine after an internal PC&P engine is accessed.

FIG. 4 is a schematic drawing of another prior art automated PC&P system capable of accessing an external automated PC&P engine before an internal PC&P engine is accessed.

FIG. 5 is a schematic drawing of the components of the PC&P system of the present invention.

FIG. 6 is a chart showing a business rule strategy for a particular lender for use in the PC&P engine launcher of the present invention.

FIG. 7 is a schematic diagram of the network environment in which the present invention is operated.

FIG. 8 is a flow chart showing the process of the present invention.

FIG. 9 is a schematic drawing showing the use present invention by a loan broker analyzing a loan application against the criteria of a plurality of lenders.

### DETAILED DESCRIPTION OF THE INVENTION

Parties to a Loan Transaction

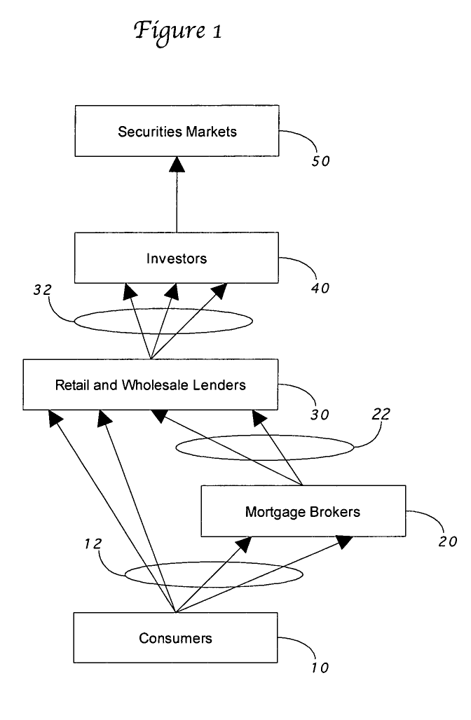

FIG. 1 shows a hierarchical tree of parties involved in large loan transactions such as a mortgage. At the bottom of the tree are the consumers 10 who are interested in obtaining financing. To obtain this loan, the consumer can approach a loan broker 20, who in turn is able to obtain loans for consumers from a variety of wholesale lenders 30. Alternatively, the consumer 10 can approach a retail lender 30 directly. The lenders 30 are the parties that make actual loans to the consumers 10, however the loan brokers 20 (and the retail lenders 30 that lend directly to the consumer 10) are referred to as the loan originators.

Although the lenders 30 are able to keep and maintain the loan throughout the life of the loan, lenders 30 will frequently sell the loan to an investor 40 in the secondary market. The investor 40 might be a government-sponsored entity such as Fannie Mae or Freddie Mac, or another investor such as GMAC-RFC (Residential Funding Corporation; Minneapolis, Minn.). These investors 40 may then package the loans into securities, and sell these securities to the securities market 50. Alternatively, the investors 40 might keep these loans, or sell the loans to another investor 40.

There are three areas 12, 22, and 32 on FIG. 1 in which multiple vendors are available and a decision must be made between those vendors. First, the consumer 10 must choose at area 12 between multiple loan brokers 20 and retail lenders 30. Second, the broker 20 must choose at area 22 between multiple lenders 30 when offering a loan to the consumer 10. Third, the lenders 30 must decide at area 32 between the different investors 40 who might purchase the loan in the secondary market. The present invention is directed at creating an intelligent mechanism for lenders 30 to choose between investors 40 (area 32), or for brokers 20 to select between multiple lenders (area 22).

Prior Art Secondary Marketing

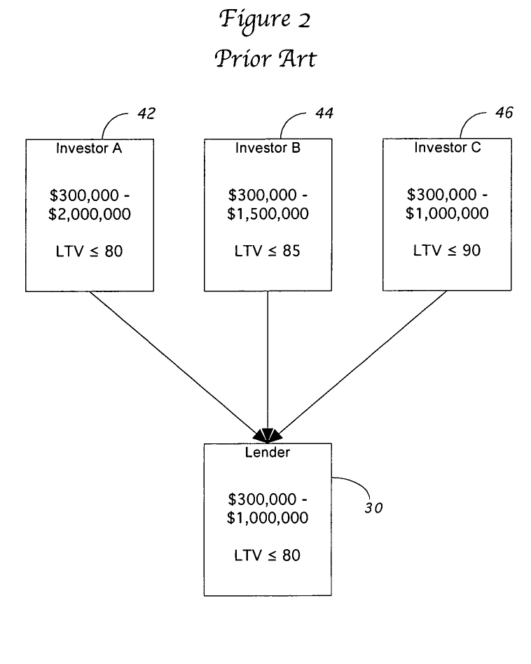

FIG. 2 shows a prior art example of a typical secondary marketing process undertaken by a lender 30. As shown in this figure, the lender 30 has three possible investors 42-46 who may be interested in purchasing a particular loan. Investor A 42 accepts all loans that have a loan amount between $300,000 and $2,000,000, and requires that the loan applicant have a loan to value ratio (LTV) of 80 or better. Similarly, Investor B 44 accepts all loans that have a loan amount between $300,000 and $1,500,000 with an LTV of 85 or under, while Investor C 46 accepts all loans that have a loan amount between $300,000 and $1,000,000 with an LTV of 90 or less.

The simplest and most common way that this is represented in secondary marketing processes at lenders is to simply accept the strictest standard from the three investors. In other words, the lender 30 will create a single, simplified set of criteria or rules with which to judge a loan. In this case, the lender 30 would require that the loan amount be between $300,000 and $1,000,000, and that the consumer 10 have an LTV of 80 or less. The combined rule set of lender 30 ensures that all three investors 42-46 will consider buying a loan that passes the combined rule set. This allows the lender 30 to combine the best loan pricing and corresponding rates from among the three investors 42-46 into a single rate sheet. The rate sheet is then used to offer loan rates and products to consumers 10 and loan brokers 20. In this way, the complexities of three separate loan criteria and three separate loan rates are combined by the lender 30 into a single, simplified loan criteria with a single, simplified rate sheet.

Of course, the rule sets for determining whether a particular investor 40 will consider purchasing a loan are much more complicated than the acceptable loan amount and the loan to value ratio shown in FIG. 2. Investors 40 such as Fannie Mae provide lenders with complex “Product Guidelines” and “Client Guides” for determining whether a loan might be purchased by the investor 40. Since each of the possible investors 40 has a different set of complex guidelines, the actual combined rule set of lender 30 is similarly complex. Nonetheless, the lender 30 generally creates a simplified rule set by accepting the strictest standards (in other words, the lowest common denominator) established by their chosen investors 40.

The published rule sets that the investors 40 provide to the lenders 30 allow the lenders 30 to predict when a loan will meet the requirement of the investor 40 for purchase. All loans that meet the criteria of the published rule set will be eligible for purchase. However, this does not mean that an investor 40 will never purchase a loan that does not meet its published guidelines. Many investors 40 have additional criteria that are utilized when a loan does not meet the published guidelines. These additional criteria are kept as trade secrets, but may be incorporated into the automated purchase criteria and pricing (“PC&P”) engines created by the investors 40, such as Fannie Mae's Desktop Underwriter and Freddie Mac's Loan Prospector. The automated PC&P engines incorporate all of the guidelines used by the investors 40, and thus are able to provide lenders 30 with an accurate determination as to whether a loan meets the criteria for being purchased.

Prior Art Automated Purchase Criteria and Pricing

FIG. 3 shows a prior art automated purchase criteria and pricing system 60 for analyzing secondary market options. This loan evaluation system accepts application loan data 62 and analyzes the data 62 against a rule set found in an internal automated PC&P engine 64. The internal PC&P engine 64 could either be custom programmed according to the needs of a particular lender 30, or could be a pre-established PC&P engine designed by a particular investor 40. The system contains programming 66 to determine whether the internal PC&P engine has approved the application loan data 62. If so, these results 68 are shown to the user of the system 60.

If the internal automated PC&P engine 64 does not accept the application loan data 62, many systems 60 would simply announce as its results 68 that the loan is referred to a manual review process for further consideration by the lender. However, some investors 40 have provided lenders 30 with automated PC&P systems that are able to submit the application loan data 62 to an external PC&P system 70. For instance, Fannie Mae's Desktop Underwriter includes the ability to submit non-conforming loans (loans that do not meet Fannie Mae's requirements) to the automated PC&P systems of GMAC-RFC or Countrywide Credit Industries, Inc. (Calabasas Calif.). In automated PC&P systems 60 such as this, non-conforming loan data can be submitted to the external automated PC&P engine 70, and then the results 68 from that engine can be returned to the users of system 60. While it would be a relatively straightforward matter from a technical point of view to combine multiple automated PC&P engines inside a single system 60, each investor 40 keeps the details of its purchase criteria and pricing practices as a trade secret. Thus, it would be unlikely that two or more investors 40 would be willing to combine their PC&P engines into the same system 60.

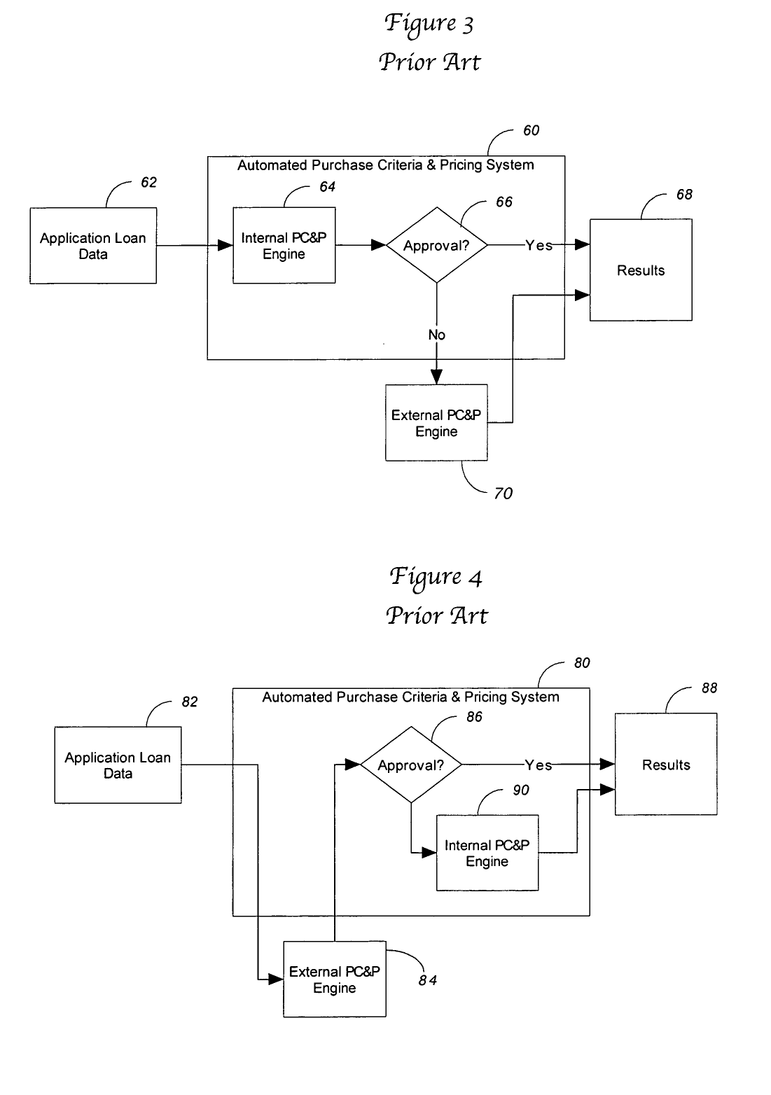

FIG. 4 shows another automated PC&P system 80 containing a simple alteration to the system 60 of FIG. 3. In system 80, the application loan data 82 is first submitted to the external automated PC&P engine 84. If approval is found at programming 86, the results 88 of the external engine 84 are presented to the user. If the external engine 84 did not approve the loan data 82, the internal automated PC&P engine 90 is then asked to analyze the application loan data 82. The results 88 of the internal engine 90 are then presented to the user.

Best Execution Purchase Criteria and Pricing System-Data Submission

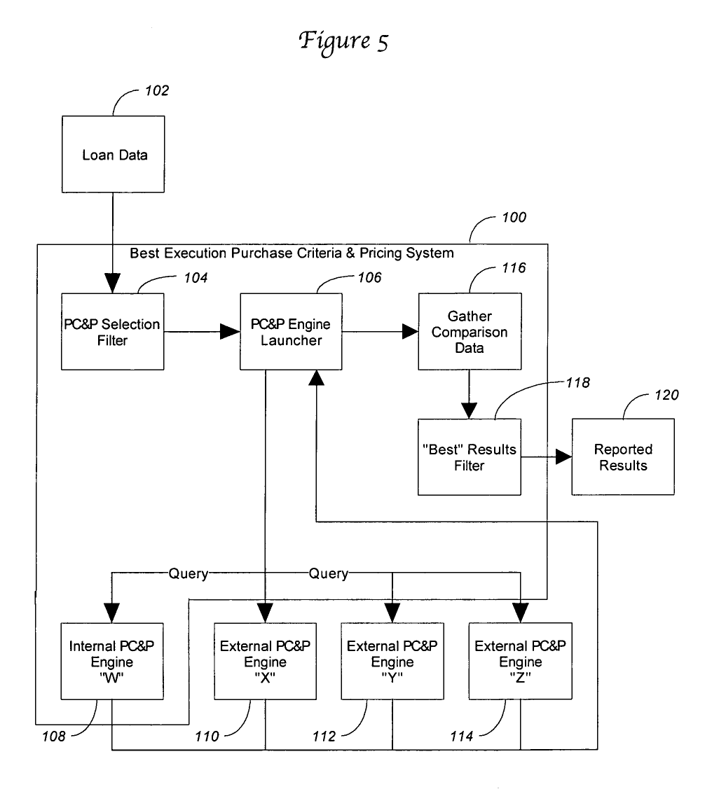

FIG. 5 shows a PC&P system 100 of the present invention. This system is labeled a “best execution” PC&P system, indicating that the system 100 is designed to implement a lender's own criteria to determine the “best” fit between a consumer's loan application and an investors' products.

The system 100 is designed to receive loan data 102 about a particular loan to a consumer 10. This data will include the identity of the consumer 10, as well as information about the consumer's finances and the property being financed. Generally, the underwriting of a loan requires an analysis of three factors, often referred to as the three Cs: collateral, credit reputation and capacity. Thus the loan application data 102 must contain enough information for these traditional factors to be fully analyzed.

In the preferred embodiment, loan data 102 is received into the system 100 using a browser interface over the World Wide Web. Other computerized interfaces would function similarly. Bulk packages consisting of many loans can also be submitted in a batch process. Where possible, it is important that the interface that receives this data 102 restricts the acceptable format and data that can be inputted through field restrictions, drop-down menus, and the like. This allows the system 100 to assume that the data 102 will be received in a known format, and there will not be a need for additional human interaction with the data before it is analyzed by the system 100.

PC&P Selection Filter

When the data 102 is input into system 100, it is received by the automated PC&P selection filter 104. This component 104, like the other components 106, 108, 116, and 118 of system 100, is preferably a programmed software component operating on a digital computer. The PC&P selection filter 104 contains information about the published loan acceptance guidelines of multiple investors 40. This information is used to screen out those investors 40 who clearly would not be willing to purchase this loan based upon the loan data 102. For instance, Fannie Mae has clearly established loan limits that must be met for the loan to be a “conforming” loan acceptable to Fannie Mae. Other investors 40 have similar published guidelines that indicate when a particular loan would likely be purchased by that investor 40. Component 104 serves to filter out those investors 40 who have no interest in this loan. It does not attempt to guess the actual results of an investor's PC&P decisions in close cases. For instance, four investors 40 (“W,” “X,” “Y,” and “Z”) may be interested in purchasing mortgages on a single-family residence. However, a mortgage on a two-family duplex may only be of interests to investor W, X, and Z, and a mortgage for commercial property may only be of interest to investor Z. Finally, investor X might not accept consumers with recent bankruptcies. This information will be known by the PC&P selection filter 104 and will be used to filter out those investors who are uninterested in the loan identified in data 102.

This description of the PC&P selection filter 104 assumes that each PC&P engine being considered (shown as engines W, X, Y, and Z 108-114 in FIG. 5) analyzes loans for only a single investor 40. However, it is possible and perhaps likely that one or more of the PC&P engines 108-114 would be capable of handling the PC&P analysis for multiple investors 40. In this case, the PC&P selection filter 104 would analyze the published guidelines for individual investors 40, and then determine which PC&P engine 108-114 analyzes PC&P decisions for those investors 40. This distinction between investors 40 and the PC&P engines 108-114 associated with the investors 40 would also be reflected in the remainder of the best execution PC&P system 100 of the present invention. However, for the sake of simplicity, the remainder of this description assumes that each automated PC&P engine analyzes loans for a single investor 40.

PC&P Engine Launcher

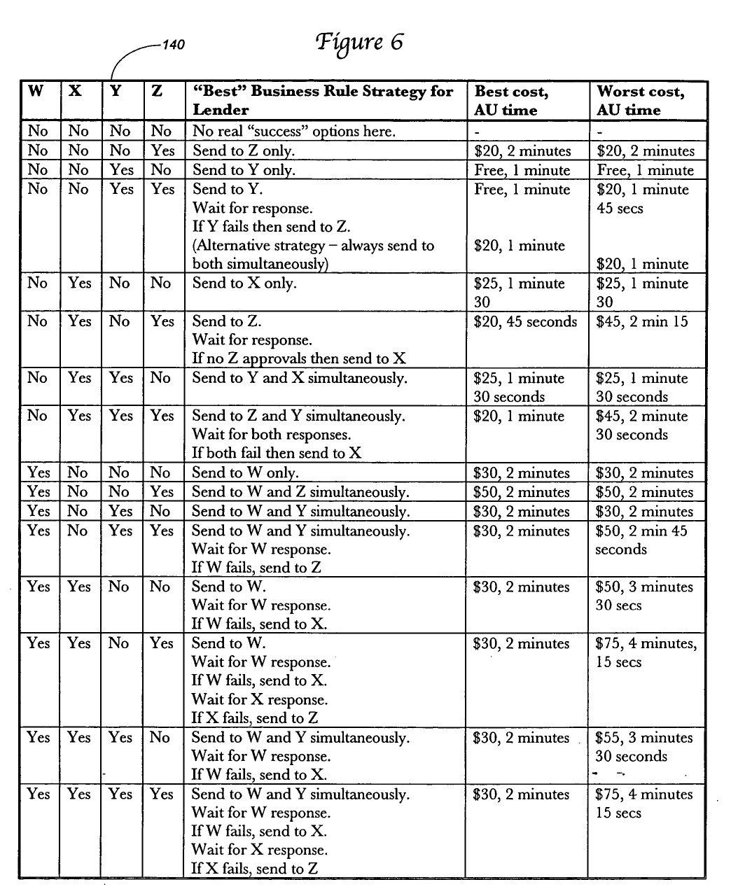

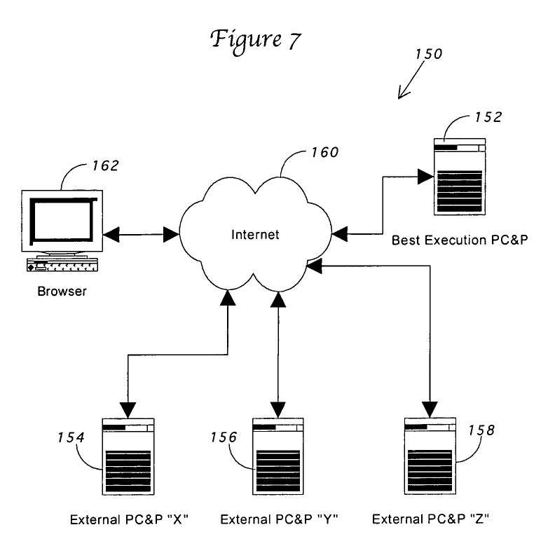

Once the PC&P selection filter 104 has identified the possible investors 40, this information is forwarded to the automated PC&P engine launcher 106. This component 106 contains business logic determined by the lender 30 about which automated PC&P engines 108-114 should be activated in particular circumstances. For instance, FIG. 6 shows a chart 140 containing business logic for a sample lender 30 that utilizes four possible investors, namely investors W, X, Y, and Z. The business logic in chart 140 consists of a plurality of strategies that should be used in various circumstances, depending upon the investors 40 identified by the PC&P selection filter 104. Of course, it would be well within the scope of the present invention to implement this business logic using another structure, as a variety of techniques for implementing business logic are known in the prior art.

This chart 140 implements various business objectives for this sample lender 30. For instance, the lender 30 realizes that the submission of loan data to an automated PC&P system 108-114 is not always free. In fact, most PC&P systems charge about $25 to $35 per loan evaluated. In addition, these engines 108-114 typically take from one to two minutes to return results after they receive data 102 for a particular loan. The hypothetical lender 30 who put together the business rules of chart 140 likely had various competing objectives in mind:

minimize fees from PC&P engines,

minimize unproductive PC&P attempts (guaranteed failures),

maximize profit for each loan,

obtain responses in a timely manner, and

comply with a general desire to use a particular investor 40 whenever possible.

These considerations can be in conflict with each other. For example, a desire to minimize fees would lead to a strategy to try PC&P engine X 110 and wait for the result and require the failure of engine X 110 before trying engine Y 112. In contrast, a desire to minimize response times would require that data be submitted to engine X 110 and engine Y simultaneously, which would also allow successful responses from both X 110 and Y112 to be compared so as to maximize the profit.

Because the goals may be in conflict, it is impossible to develop a system that meets these goals in an optimum way for all lenders 30. As a result, the present invention system 100 allows each lender 30 to define their best results for each possible combination of results received from the PC&P selection filter 104. Chart 140 shows that the lender 30 is able to provide business logic to handle all possible results as to the availability of PC&P engines W, X, Y, and Z 108-114 as determined by PC&P selection filter 104. Chart 140 assumes that:

engine W 108 costs $30 per submission and will take two minutes for a response;

engine X 110 costs $25 and takes one minute, thirty seconds;

engine Y 112 costs nothing and takes one minute; and

engine Z 114 costs $20 and takes forty-five seconds.

For each possibility, chart 140 shows the best business rule strategy as determined by the lender 30. These business rules reflects one particular lender's balancing of the competing goals of timeliness, limited submission costs, maximizing profits, and preferences between investors 40. The chart 140 also shows the best cost and approximate time as well as the worst cost and approximate time for each possibility of available investors 40. The timing shown in the last column of FIG. 6 is sometimes less than the theoretical maximum in an attempt to reflect actual results from implementing such strategies with real world automated PC&P engines.

Although not shown in FIG. 6, it is anticipated that a lender 30 will occasionally wish to stop the submission process on the occurrence of some event, and then manually review the results. In these circumstances, the user would likely be given the option to continue the effort to determine the best results, stop processing additional search engines and return only the current results, or to cancel all processing of the loan application data 102 altogether. These manual interventions can be included in the business rule strategy shown in chart 140 and can be easily implemented by the best execution PC&P system 100.

Returning to FIG. 5, the PC&P engine launcher 106 implements the best business rule strategy for the lender 30, such as that shown in FIG. 6. These rules can be implemented using a variety of techniques, including hard coding the rules into the programming of the PC&P engine launcher 106. The preferred embodiment, however, utilizes a business rule engine such as is well known in the prior art. Business rule engines allow non-programmers to program business rules such seen in chart 140 using a relatively simple user interface. The business rule engine then implements those rules by submitting the data 102 to the appropriate PC&P engine 108-114 at the appropriate time.

Note that only internal PC&P engine W 108 is shown within the system 100 of the present invention. The remaining PC&P engines 110-114 exist outside of the system 100, and will likely be unchanged or updated versions of existing PC&P engines produced by investors 40. These engines 108-114 need not have any knowledge of the workings of the best execution PC&P system 100, as they simply receive loan data 102 and return results as they are currently programmed to do. In order for the PC&P engine launcher 106 to work with unaltered PC&P engines 108-114, the engine launcher 106 must be able to convert the loan application 102 into a format expected by each PC&P engine 108-114.

The engine launcher 106 must also be capable of converting the results from each engine 108-114 into a common format for interpretation and comparison. This is accomplished by identifying data that is identical, or similar but not identical in each result. This data will be presented so that it can easily be compared between the results returned by each of the PC&P engines 108-114. Data that is unique to a particular engine 108-114 will not be ignored and will be included in the converted results. However, such data obviously cannot be easily compared to the results from other engines 108-114.

As shown in FIG. 5, the results from each engine 108-114 are returned directly to the PC&P engine launcher 106. This allows the engine launcher 106 to examine the results from one PC&P engine 108-114 before submitting the loan application data 102 to the next engine 108-114 if so desired by the lender 30. Thus, the PC&P engine launcher 106 can implement the best business logic of a lender 30, including the launching of engines 108-114 in serial or parallel, and the use of conditionals that depend on the results of earlier submissions.

Gather Comparison Data

Once the PC&P engine launcher 106 has submitted the loan data 102 to the PC&P engines 108-114, the results are forwarded to component 116 to gather additional comparison data. It is anticipated that the results will include multiple products from multiple investors 40. For each product that was approved, the results will include an indicative price the investor 40 will pay for the loan and information to allow the calculation of a post-feature price for that investor 40.

The results will also include the additional requirements that the investor 40 imposes before the loan will be accepted. These requirements include such things as the need for a complete appraisal of the property, two years of tax returns, or other preparation requirements. These additional requirements can be assigned a financial value based upon the experiences of the individual lender 30. For instance, the lender would know that a certain investor package takes three hours to prepare and costs $70, an appraisal costs $250 passed on to the consumer 10, and that the requirement for tax returns costs $50 out-of-pocket.

The lender may also wish to assign values for additional activities. For instance, if one loan product generally requires an extra hour on the telephone, a lender may assign a cost of $25 to this additional labor. In addition, if the lender can obtain the cash from a loan one week ahead of “standard,” they may value this at an amount equal to 0.125% of the loan amount.

The gather comparison data component 116 of the present invention analyzes this data and assigns a cost to each element. The component 116 also is capable of calculating the post-feature price for the each of the multiple products that were discovered by the PC&P engine launcher 106.

Best Results Filter and Reported Results

The calculations from component 116 are then presented to the “best” results filter 118 for analysis. This filter examines each of the multiple products and their related costs and benefits as calculated by the gather comparison data component 116. The lender 30 can then specify the business rules that will be used to determine the “best” products for this loan. The lender 30 may wish to look at the best pre-feature price, the best post-feature price, the costs to produce the loan, the costs and convenience to the consumer 10, or some combination of these values. Since the lender 30 determines how this analysis takes place, the results of this analysis can be completely tailored to meet the lender's understanding of which results are “best.” Those results that do not meet this understanding are filtered out.

The results considered to be best are then presented to the user as the reported results 120. Generally, the reported results 120 are presented in a common format so that the user can easily compare the best products between different investors 40. In the preferred embodiment, these results contain calculation results and related messages produced by the best results filter 118.

Best Execution Purchase Criteria and Pricing System Environment

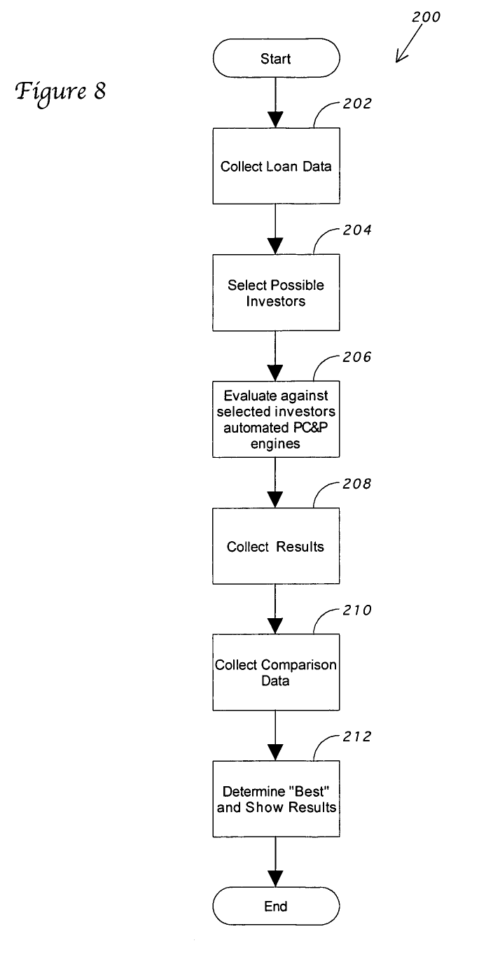

FIG. 7 shows the environment 150 in which the present invention system 100 operates. The system 100 operates on a best execution computer 152, while the external PC&P engines 110-114 operate on separate computers 154-158. These computers 152-158 are interconnected through a digital network such as the Internet 160. The loan application data 102 is preferably entered into the system 100 on computer 152 through a browser interface 162 also connected to the Internet 160 or via a batch process.

While FIG. 7 shows the system 100 and engines 110-114 operating on separate servers or mini computers 152-158, it would be within the scope of the invention to operate two or more of the system 100 and engines 110-114 on a single computer. In addition, although FIG. 7 shows the various components communicating over a public network such as the Internet, it would be obvious to one of ordinary skill to connect the computers through more private networks and connections, such as by using ATM or leased-lines.

Best Execution Process

The process 200 used by the present invention is set forth in FIG. 8. The first step 202 in this process is to collect the information 102 about the loan that will enable the loan to be analyzed. Step 202 can be performed through any computerized system having an interface for the entry of such data 102. Ideally, the interface would be provided over the World Wide Web or another network providing similar functionality.

Once the loan data 102 has been collected, step 204 does a preliminary analysis to determine which investors 40 should be further explored. This analysis uses the published guidelines of the investors 40 to help predict an investor's attitude toward a particular loan. If it is clear that one of the investors 40 is not interested in a particular loan, the investor 40 is screened out.

Once one or more investors 40 are selected in step 204, step 206 submits the data collected about the loan to the automated PC&P engines 108-114 of the selected investors 40. This step 206 ideally will implement business logic defined by the lender 30 to guide the submission process. For example, if the lender 30 has a clear bias toward one of the investors 40, the lender 30 may wish to submit the loan data to the engine 108-114 used by this investor 40 before sending the data to any other investor 40.

Each of these automated PC&P engines 108-114 that receive a submission will then return PC&P results based on their analysis of the loan data 102. The results are collected by the process 200 in step 208 and are converted into a common format. Step 210 then proceeds to collect additional pricing data so that a specific loan can be priced against multiple pricing options. It is here that a lender 30 can assign values to particular requirements that the investors 40 included in their results.

At this point, step 212 then analyzes the pricing data for the possible investors and presents a “best” option utilizing the specific business criteria specified by the lender 30. It is anticipated that the lender 30 will examine such factors as pre-feature price, post-feature price, and the costs to lender. Products found in the results that were not determined to be among the “best” products are either filtered out of the data presented to the user, or are sorted and ranked in such a way as to make clear to the lender 30 which are the “best” products found.

Best Execution Processing By Broker

The best execution PC&P system 100 was described above in the context of a lender 30 selecting between multiple investors 40, shown as area 32 in FIG. 1. The present invention system 100 can also be used by a loan broker 20 selecting between multiple lenders 30 at area 22 of FIG. 1.

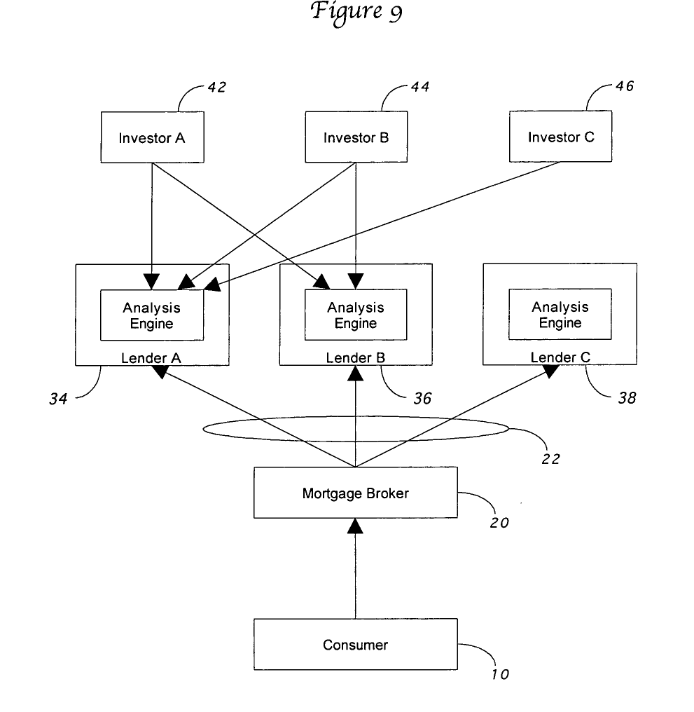

As seen in FIG. 9, area 22 requires that a broker 20 select between multiple wholesale lenders 30, such as lender A 34, lender B 36, and lender C 48. Each of these lenders 34-38 will likely utilize an automated engine to help process loan data according to the criteria established by each lender 34-38. It is likely that one or more of these lenders 34-38 will process loan data that it receives in accordance with the loan criteria of the investors 40 with which they typically do business, such as investor A 42, investor B 44, and investor C 46 as shown in FIG. 9. This means that lenders 34-38 take into account the loan criteria of these investors 42-46 when the lenders 34-38 create their automatic engines. In FIG. 9, lender A 34 works with all three investors 42-46, and hence the engine of lender A 34 may reflect the combined criteria of all three investors 42-46. The engine of lender A 34 could be a best execution PC&P engine of the present invention. In this case, the PC&P engine would receive loan data from the broker 20, determine the best match of the possible investors 42-46 using the process described above, and return results relating to the best match to the broker 20. Alternatively, the loan evaluation engine used by lender A 34 could be a prior art engine such as those shown in FIGS. 3 and 4. Similarly, lender B 36 works with investor A 42 and investor B 44, meaning that the engine of lender B 36 will reflect the PC&P criteria of these two investors 42-44. Lender C 38 does not work directly with any of the investors 42-46, and hence the criteria of its engine will be internally developed. In each of these cases, the broker 20 need not be aware of the internal logistics of the loan evaluation engines used by the various lenders 34-38. Rather, the broker 20 is only aware that loan data can be submitted to these engines, with acceptance criteria and pricing information being returned.

The loan broker 20 can use the best execution loan evaluation system 100 to help select an appropriate lender 34-38 for a particular loan application. The PC&P engine launcher 106, with the help of the PC&P selection filter 104, uses business rules defined by the broker 20 to help select which lenders 34-38 should receive the loan data for processing by their engines. Engine launcher 106 then receives results from the multiple engines, module 116 gathers the comparison data, and best results filer 118 then selects the best results 120.

The invention is not to be taken as limited to all of the details thereof as modifications and variations thereof may be made without departing from the spirit or scope of the invention. For instance, the above description divides the steps and processes of the present invention system 100 into separate components 104, 106, 108, 116, and 118. It would be obvious to one of ordinary skill that the functions of these components can be grouped together into fewer components, separated into more components, or otherwise be subdivided differently without altering the present invention. Consequently, the invention should be limited only by the following claims.

What is claimed is:

1. A system for submitting loan data to a plurality of automated loan evaluation engines, each automated loan evaluation engine programmed to receive loan data and return results, comprising:
a) an engine launcher in communication with the plurality of automated engines, the engine launcher submitting loan data to the automated engines and receiving results from the automated engines, the engine launcher submitting loan data under the control of a set of business rules; and
b) a best results filter that determines a set of best results from the results received by the engine launcher based upon financial data associated with the results.

2. The system of claim 1, further comprising:
c) a selection filter that compares the loan data to published guidelines for the plurality of automated engines and creates a selected subset of automated engines based upon the comparison;
wherein the engine launcher submits the loan data only to the selected subset of automated engines.

3. The system of claim 2, wherein the business rules define a plurality of strategies, with each strategy being associated with a particular subset of automated engines.

4. The system of claim 1, wherein the automated engines impose requirements to be accomplished along with their results, and the best results filter determines the set of best results in part by assigning financial costs to the requirements imposed on the results.

5. A system for analyzing interest from a plurality of investors in purchasing a loan from a lender comprising:
a) a selection filter that compares loan data to published guidelines for the plurality of investors and creates a selected set of investors from the plurality of investors based upon the comparison;
b) a plurality of automated engines associated with the plurality of investors, each automated engine programmed to receive loan data and return results;
c) an engine launcher in communication with the selection filter and the plurality of automated engines, the engine launcher submitting loan data to the automated engines under the control of predefined business rules, and the engine launcher receiving results from the automated engines; and
d) a best results filter that determines a set of best results from the results received by the engine launcher based upon financial data associated with the results.

6. A method for submitting loan data to a plurality of automated engines, the method comprising the steps of:
a) collecting the loan data;
b) selecting from among the plurality of automated engines a selected subset of automated engines based upon content of the loan data;
c) submitting the loan data to the subset of automated engines according to business rules;
d) receiving a plurality of results from the automated engines;
e) selecting a set of best results by comparing financial data related to the plurality results; and
f) presenting the set of best results.

7. The method of claim 6, wherein the step of selecting a selected subset of automated engines further comprises comparing the loan data to published guidelines for the plurality of automated engines.

8. The system of claim 7, wherein the business rules define a plurality of strategies, with each strategy being associated with a particular subset of automated engines.

9. The system of claim 6, wherein the automated engines impose requirements to be accomplished along with their results, and wherein the step of selecting a set of best results further comprises assigning financial costs or preferences to the requirements imposed on the results.

10. A method for analyzing interest from a plurality of investors in purchasing a loan from a lender, the method comprising the steps of:
a) collecting loan data about the loan;
b) selecting from among the plurality of investors a selected set of investors willing to purchase the loan based upon content of the loan data;
c) submitting the loan data to one or more automated engines associated with the selected set of investors;
d) receiving a plurality of results from the automated engines;
e) comparing financial data related to the results to select a subset of best results from the plurality of results; and
f) presenting the best results.

11. The method of claim 10, wherein the step of comparing financial data includes the step of assigning financial costs to requirements imposed on the results by the investors.

12. The method of claim 10, wherein the selected set of investors is a subset of the plurality of investors, whereby at least one investor is excluded from the selected set based upon the content of the loan data.
